(19) United States
(12) Patent Application Publication
(10) Pub. No.: US 2023/0255247 A1
(43) Pub. Date: Aug. 17, 2023

(54) SPOONABLE FOOD COMPOSITION

(71) Applicant: SOCIETE DES PRODUITS NESTLE S.A., Vevey (CH)

(72) Inventors: JOYDEEP RAY, Epalinges (CH); REMCO POSLUSCHNY, Dannenberg (DE); GREGORY LEFEBVRE, Vullierens (CH)

(21) Appl. No.: 18/003,043

(22) PCT Filed: Jun. 18, 2021
(86) PCT No.: PCT/EP2021/066718

§ 371 Date: Dec. 22, 2022

(30) Foreign Application Priority Data
Jun. 26, 2020 (EP) 20182467.9
Jun. 26, 2020 (EP) 20182471.1
Jun. 26, 2020 (EP) 20182475.2

(51) Int. Cl. A23L 19/00; A23L 25/00; A23L 3/10; A23L 33/185; A23L 7/10

(52) U.S. Cl. CPC A23L 19/09; A23L 25/30; A23L 3/10; A23L 33/185; A23L 7/198

(57) ABSTRACT

The present invention relates generally to the field of spoonable food compositions that can be distributed via the ambient channel One embodiment of the present invention relates to a spoonable ambient food composition. The spoonable food composition of the present invention can be used as a meal alternative.

The present invention relates generally to the field of spoonable food compositions that can be distributed via the ambient channel. The spoonable food composition of the present invention can be used as a meal alternative. For example, the spoonable food composition of the present invention may further comprise pea protein, and oat flour.

In modern society today, people consume more and more meals out-of-home, for example, in the office or on-the-go. In view of these trends, the street food business is growing. More and more supermarkets, restaurant and specialist shops offer snacks or meals as take-away option.

However, many of these offerings are difficult to eat without the risk of spilling food on someone's clothes. To reduce this risk, these offerings are often sold with a lot of one-way cutlery and packaging. However, this can be problematic in view of the challenges the world is facing with respect to packaging waste, in particular packaging waste that cannot be recycled or biodegraded.

Also, many of these out-of-home meal solutions are considered unhealthy.

Further, while available meal solutions may be useful to overcome hunger and a lack of energy, they frequently do not have a nutritional profile that resembles a complete meal.

Even further, many of these on-the-go solutions are freshly prepared and/or have a short shelf life. While freshly prepared food is considered healthy by consumers, its short shelf life can lead to relatively high amounts of food waste and it does not allow consumers to stock-up on such meal solutions. This can lead to higher transport costs and time loss.

Increasingly, consumers value an excellent nutritional profile—also for on-the-go meal solutions—as the contribution of good nutrition to a healthy lifestyle is increasingly recognized; and more and more consumers see a healthy lifestyle as a key contributor to a happy and healthy life.

Several drinkable food compositions are on the market that address this need. However, a consumer looking for a food composition that can be used to replace a meal often looks for a composition that can be chewed, as chewing typically leads to more satisfaction from a food composition.

Also, increasingly, consumers wish to reduce their meat consumption. As such, the number of consumers preferring a flexitarian, a vegetarian or a vegan diet is increasing globally.

Even further, for example driven by the globalization of food, consumers become more and more curious to explore new and/or unusual flavor combinations and/or textures.

In view of all this, there is a need for complete meal solutions, that are convenient to use and require no preparation steps, have an excellent nutritional profile, are suitable for a vegetarian or a vegan lifestyle, are free from food additives, and offer an exciting flavor and texture profile.

It would therefore be desirable to have available a complete meal solution, that satisfies these needs and/or overcomes some of the problems with the solutions that presently exist on the market.

Any reference to prior art documents in this specification is not to be considered an admission that such prior art is widely known or forms part of the common general knowledge in the field.

The objective of the present invention was it to enrich or improve the state of the art and in particular to provide a complete meal solution with an exciting flavor and texture profile, that is satisfying when consumed, is convenient to use and requires no preparation steps, has an excellent nutritional profile, is suitable for a vegetarian or a vegan lifestyle, only contains ingredients that a consumer is well familiar with, is free from food additives, and can be distributed via the ambient distribution channel or to at least provide a useful alternative to existing solutions.

The inventors were surprised to see that the objective of the present invention could be achieved by the subject matter of the independent claims. The dependent claims further develop the idea of the present invention.

Accordingly, the present invention provides a spoonable ambient food composition comprising pea protein, and oat flour.

In one embodiment, the spoonable ambient food composition further comprises beetroot, fig, rhubarb, parsnip, pomegranate, apple, grape, cherry, and carrot.

In one embodiment, the spoonable ambient food composition further comprises cocoa, and purees or juices from raspberry, apple, fig, banana, cauliflower, and pear.

In one embodiment, the spoonable ambient food composition further comprises pumpkin, pineapple, apricot, apple, grape, sweet potato and lemon.

The present invention further provides a single serve pack comprising the composition in accordance with the present invention.

As used in this specification, the words “comprises”, “comprising”, and similar words, are not to be interpreted in an exclusive or exhaustive sense. In other words, they are intended to mean “including, but not limited to”.

The present inventors have shown that the composition of the present invention and the single serve pack of the present invention achieve the objective of the present invention.

The inventors have defined a complete meal solution to be a composition that comprises per serving about 400-600 kcal, at least about 15 g protein, less than about 18 g fat, less than about 25 g total sugars, at least about 6 g fiber and less than about 600 mg salt.

The total energy requirement of between 400 and 600 kcal is based on the assumption that a main meal should provide about 20-30% of the recommended total daily energy consumption (normally about 2′000 kcal/day). The minimal protein content of 15 g would provide 30% of the recommended daily protein intake. The maximal fat content of 18 g limits the fat content to less than 25% of the recommended daily fat intake. The maximal sugar content of 25 g limits the sugar content to less than 25% of the recommended daily sugar intake. The minimal fiber content of 6 g would provide 25% of the recommended daily fiber intake. The maximal sodium content of 600 mg limits the sodium content to less than 35% of the 2000 mg daily reference value.

The present inventors were surprised to be able to propose a complete meal solution with an exciting new flavor and texture experience, while avoiding the addition of sugar, salt, preservatives, colors or artificial flavors, solely through the combination of fruit, vegetables, nuts, seeds with cocoa, pea protein and oat flour.

A taste test has revealed that this composition is particularly preferred by consumers and clearly stands out from other meal solutions available on the market today.

Remarkably, the present inventors were able to propose a complete meal solution that is suitable for the ambient distribution channel and only contains ingredients that the consumer knows from in-home cooking.

Consequently, the present invention relates in part to a spoonable ambient food composition comprising pea protein, and oat flour.

In one embodiment, the spoonable ambient food composition further comprises beetroot, fig, rhubarb, parsnip, pomegranate, apple, grape, cherry, and carrot.

In one embodiment, the spoonable ambient food composition further comprises cocoa, and purees or juices from raspberry, apple, fig, banana, cauliflower, and pear.

In one embodiment, the spoonable ambient food composition further comprises pumpkin, pineapple, apricot, apple, grape, sweet potato and lemon.

For the purpose of the present invention the term “spoonable” shall mean that the ambient food composition can be consumed with a spoon. For example, the term “spoonable” may mean that the ambient food composition is best consumed with a spoon. Even further, for example, the ambient food composition of the present invention may not be drinkable, in other words may have a consistency that makes drinking unpleasant or even impossible.

The composition of the present invention is an ambient composition. The term “ambient” may mean that the composition can—but does not have to—be refrigerated during storage. For example, ambient storage conditions may mean storage in a dry, clean, well ventilated area at room temperatures between 15° to 30° C., depending on climatic conditions. An ambient composition may be a composition that can be stored in ambient storage conditions for at least about 6 weeks, at least about 2 months, or at least about 3 months.

In accordance with Codex Alimentarius the term “food” may mean any substance, whether processed, semi-processed or raw, which is intended for human consumption, and includes drink, chewing gum and any substance which has been used in the manufacture, preparation or treatment of “food” but does not include cosmetics or tobacco or substances used only as drugs.

The inventors were able to identify a unique combination of fruit and vegetables that allows it to achieve the objective of the present invention while providing a unique taste sensation.

This is even more remarkable in view of the fact that the composition of the present invention comprises pea protein. Pea protein is usually regarded as excellent protein source as peas are usually not genetically modified, comprise about 90% protein and all nine essential amino acids—valine, phenylalanine, threonine, methionine, tryptophan, isoleucine, lysine, histidine, and leucine. However, the taste of pea protein is usually described as bitter, grassy, beany, earthy, and/or chalky. Hence, it is challenging to manufacture a composition comprising pea protein with a good taste profile.

The unique, spoonable texture of the composition is achieved through the use of purees in combination with pea protein, cocoa and oat flour, which give the composition a certain chewiness, which is well balanced by juices that are also part of the composition.

For example, the spoonable ambient food composition may comprise pea protein and oat flour.

In one embodiment, the spoonable ambient food composition further comprises beetroot, fig, rhubarb, parsnip, pomegranate, apple, grape, cherry, and carrot.

In one embodiment, the spoonable ambient food composition further comprises cocoa, and purees or juices from raspberry, apple, fig, banana, cauliflower, and pear.

In one embodiment, the spoonable ambient food composition further comprises pumpkin, pineapple, apricot, apple, grape, sweet potato and lemon.

Some or all ingredients of the composition of the present invention may be labelled as “organic”. As a result, the composition of the present invention may be an organic composition.

The spoonable ambient food composition in accordance with the present invention may further comprise comprising (a) Lemon juice and/or natural rosemary flavouring; or (b) Lemon juice and/or blueberry juice; or (c) ginger juice, coconut milk, turmeric.

Lemon juice may be used to elevate a certain freshness in the flavor profile of the composition of the present invention. Lemon juice may also be used to adjust the pH of the present invention to an acidic pH, for example a pH of 4.5 or less. This will lead to a prolonged shelf life of the composition of the present invention.

The present inventors have achieved it to combine the spoonable, relatively dense consistency of the composition of the present invention with a surprisingly light, fresh and fruity flavor profile. This makes the composition even more pleasurable to consume and will enable consumers to finish a typical 300 g portion of the composition of the present invention easily, and to feel pleasantly satisfied thereafter without feeling too full.

For example, the spoonable ambient food composition in accordance with the present invention may comprise at least about 2 weight-% pea protein, at least about 7 weight-% oat flour, at least about 13 weight-% beetroot puree, at least about 13 weight-% pomegranate juice, at least about 10 weight-% fig puree, at least about 7 weight-% grape juice, at least about 6 weight-% cherry juice, at least about 5 weight-% rhubarb puree, at least about 5 weight-% parsnip puree, and at least about 3 weight-% carrot juice.

One embodiment of the spoonable ambient food composition in accordance with the present invention may comprise about 2-4 weight-% pea protein, about 8-9 weight-% oat flour, about 14-15 weight-% beetroot puree, about 14-15 weight-% pomegranate juice, about 11-12 weight-% fig puree, about 7-9 weight-% grape juice, about 6-7 weight-% cherry juice, about 5-7 weight-% rhubarb puree, about 5-7 weight-% parsnip puree, and about 3-5 weight-% carrot juice.

For example, the spoonable ambient food composition in accordance with the present invention may comprise at least about 1.5 weight-% pea protein, at least about 7 weight % oat flour, at least about 2 weight-% cocoa, at least about 18 weight-% raspberry puree, at least about 16 weight-% apple juice, at least about 10 weight-% fig puree, at least about 7 weight-% banana puree, at least about 7 weight-% cauliflower puree, and at least about 7 weight-% pear puree.

One embodiment of the spoonable ambient food composition in accordance with the present invention may comprise about 1.5-3 weight-% pea protein, about 7-9.5 weight % oat flour, about 2-3 weight-% cocoa, about 18-21 weight-% raspberry puree, about 16-19 weight-% apple juice, about 10-13 weight-% fig puree, about 7-9 weight-% banana puree, about 7-9 weight-% cauliflower puree, and about 7-9 weight-% pear puree.

For example, the spoonable ambient food composition in accordance with the present invention may comprise at least about 2 weight-% pea protein, at least about 7 weight % oat flour, at least about 18 weight-% pumpkin puree, at least about 10 weight-% pineapple juice, at least about 10 weight-% apricot juice, at least about 9 weight-% apple juice, at least about 8 weight-% grape juice, at least about 5 weight-% sweet potato puree, and at least about 5 weight-% lemon juice.

One embodiment of the spoonable ambient food composition in accordance with the present invention may comprise about 2-4 weight-% pea protein, about 7-9 weight % oat flour, about 18-20 weight-% pumpkin puree, about 10-13 weight-% pineapple juice, about 10-13 weight-% apricot juice, about 9-11 weight-% apple juice, about 8-11 weight-% grape juice, about 5-7 weight-% sweet potato puree, and about 5-7 weight-% lemon juice.

The spoonable ambient food composition in accordance with the present invention may have a viscosity in the range of about 20-25 Pas at 10⁻⁵ shear rate.

To further enhance the nutritional profile of the composition of the present invention and to enhance the pleasurable experience during consumption another texture may be introduced into the composition of the present invention. For example, the composition of the present invention may further comprise a nut and seed mix. To enhance the flavor of the nut and seed mix, the nuts and seeds may be used in a toasted form. The nut and seed mix may be a part of the composition of the present invention or may be provided in a separate part of the packaging, so that they can be added to the composition immediately prior to the consumption moment.

Hence, the spoonable ambient food composition in accordance with the present invention may further comprises a nut and seed mix. A person skilled in the art will be able to propose an appropriate nut and seed selection. The inventors have achieved excellent results when the nut and seed mix comprised nuts and seeds selected from the group consisting of walnuts, pistachios, sunflower seeds, pumpkin seeds, or combinations thereof.

The composition of the present invention may be prepared by mixing and homogenizing the ingredients, optionally adding a nut and seed mixture, filling the mixture into a retortable packaging and pasteurizing the composition in the retortable packaging. The retortable packaging may be a recyclable and/or biodegradable retortable packaging. For example, the retortable packaging may be a carton, a cup or a pouch. In terms of ease of consumption, the inventors have achieved best results with a retortable cup.

For example, the spoonable ambient food composition in accordance with the present invention may be obtainable by a method comprising the steps of:
mixing of the wet ingredients,
addition of the dry ingredients, and further mixing to ensure hydration and homogeneity,
adjustment of the pH to 4.5 or less, for example through the addition of lemon juice,
filling of the resulting product into retortable packaging,
pasteurization of the product in the retortable packaging at a temperature in the range of about 90-100° C., and
cooling of the product.

A person skilled in the art will be able to adapt the pasteurization conditions appropriately.

The spoonable composition of the present invention may be for use as a complete meal solution. As such, it is preferred if the composition contains appropriate amounts of energy, protein, fat and carbohydrates.

For example, the spoonable ambient food composition may comprise per 100 g about 500-600 kJ, about 6-7 g protein, about 4.5-5.5 fat, and about 10-20 g carbohydrates.

For example, the spoonable ambient food composition may comprise per 100 g about 550-650 kJ, about 6-8 g protein, about 5-6 g fat, and about 12-17 g carbohydrates.

For example, the spoonable ambient food composition in accordance with the present invention may comprise per 100 g about 500-600 kJ, about 6-7 g protein, about 5-6 g fat, and about 10-15 g carbohydrates.

Next to macronutrients, it may be preferable, if the composition of the present invention provides a selection of micronutrients, such as vitamins and minerals.

For example, the spoonable ambient food composition in accordance with the present invention may comprises per 300 g about 20-25% DI vitamin C, about 12-18% DI vitamin B6, about 12-18% DI potassium, about 35-45% DI phosphorous, about 30-35% DI magnesium, about 15-25% DI iron, and/or about 10-20% DI zinc.

For example, the spoonable ambient food composition in accordance with the present invention may comprises per 100 g about 12-18% DI vitamin E, about 18-23% DI vitamin C, about 18-23% DI vitamin B6, about 20-25% DI potassium, about 40-46% DI phosphorous, about 40-50% DI magnesium, about 30-35% DI iron, and/or about 15-20% DI zinc.

For example, the spoonable ambient food composition in accordance with the present invention may comprises per 100 g about 25-30% DI vitamin E, about 20-25% DI vitamin B6, about 12-18% DI potassium, about 35-45% DI phosphorous, about 30-35% DI magnesium, about 15-25% DI iron, and/or about 10-20% DI zinc.

Several compositions available on the market today contain similar micronutrients. However, usually, these micronutrient profiles are achieved by supplementation of these micronutrients. The present inventors have aimed not to use any artificial micronutrient fortification in the formulation of the composition of the present invention. Instead they were surprised to be able to achieve these micronutrient profile through the selection and combination of the plant-based ingredients used in the composition of the present invention. Hence, in one embodiment of the present invention, the composition of the present invention is not fortified with vitamins or minerals.

To enhance and underline flavor profiles compositions of the prior art often contain added sugar or added salt. However, more and more consumers wish to reduce the sugar and/or salt intake, in particular their intake of added sugar or salt.

The present inventors were surprised to see that they could produce the composition of the present invention with a preferred flavor profile without the addition of sugar or salt. Hence, the spoonable ambient food composition in accordance with the present invention may comprise no added sugar and/or no added salt.

One of the advantages of the composition of the present invention is that it can be free of meat and/or fish. It can additionally or alternatively be free of eggs and/or of milk and/or milk products. As such, the composition can be suitable for the flexitarian, vegetarian and/or even vegan diet. Hence, the spoonable ambient food composition in accordance with the present invention can be a vegetarian composition and/or a vegan composition.

Oat flour is gluten free. Hence, the spoonable ambient food composition in accordance with the present invention can be gluten-free.

When consumers look for a complete meal solution, they typically do so to replace partially or completely breakfast, lunch or dinner. Consumer liking shows that the composition of the present invention is in particular preferred to replace lunch or dinner. Hence, the spoonable ambient food composition in accordance with the present invention can be used to replace a complete meal. For example, it can be used to replace breakfast, lunch and/or dinner; preferably lunch and/or dinner.

One advantage of the present invention is that it does not require refrigeration during transport and/or storage. This makes the composition ideal for use as a meal option out-of-home; for example, on the road or in the office; in particular, if no refrigeration is available. This also allows that after production or during transport, for example, to retailers, no refrigeration is required. This allows to save significant amounts of energy. Also speed becomes less important during storage. It further allows consumers to purchase lager amounts of the composition of the present invention and to stock-up without blocking space in the refrigerator. Hence, the spoonable ambient food composition in accordance with the present invention may be to be distributed through the ambient food chain.

As the composition of the present invention may be to be used as complete meal solution which can be consumed out-of-home and/or on-the-go it may be preferable, if the composition is packaged in single serve packs or in bundles of single serve packs. The single serve pack comprises one portion of the composition of the present invention. For example, one portion of a composition of the present invention may comprise about 150-500 g, about 200-400 g or about 250-350 g. Hence, a single serve pack comprising the composition in accordance with the present invention may comprises about 250-350 g of the composition of the present invention.

The single serve pack of the present invention may further comprise a nut and seed mix separated from the composition. This has the advantage that the nut and seed mixture stays crunchy. Such a separation may be, for example, achieved through a split pot, or through a sachet comprising the nuts and seeds which is packaged with the single serve pack. Hence, in the single serve pack comprising the composition in accordance with the present invention, the nut and seed mix may be separated from the composition in the single serve pack and may be to be added to the composition before consumption.

The single serve pack in accordance with the present invention comprising the composition of the present invention may be pasteurized. As such, the single serve pack may have a shelf life at ambient conditions of at least 4 months, of at least 5 months, or of at least 6 months.

Those skilled in the art will understand that they can freely combine all features of the present invention disclosed herein. In particular, features described for the food composition of the present invention may be combined with features for the single serve pack of the present invention and vice versa. Further, features described for different embodiments of the present invention may be combined.

Although the invention has been described by way of example, it should be appreciated that variations and modifications may be made without departing from the scope of the invention as defined in the claims.

Furthermore, where known equivalents exist to specific features, such equivalents are incorporated as if specifically referred in this specification. Further advantages and features of the present invention are apparent from the figures and non-limiting examples.

### EXAMPLES

Methods:

Rheological Analyses

Rheological measurements were performed for the spoonable ambient food composition in a stress-controlled rheometer (MCR 501, Anton Paar) with a sandblasted, 50 mm diameter, parallel plate geometry, 50 mm and a 1 mm gap.

Viscometry

A 1-minute pre-shearing step at a constant shear rate of 100 s⁻¹ was applied in order to ensure all samples were subjected to the same deformation history. Viscosity measurements consisted of shear rate ramps from 0.1 s⁻¹ and 1000 s⁻¹ and from 1000 s⁻¹ to 0.1 s⁻¹, and at a constant temperature of 20° C.

Small-Amplitude Oscillation

The strain sweep measurements were carried out by increasing strain amplitude in discrete steps at a constant frequency of 1 Hz, and at constant temperature of 20° C.

### Example 1

A composition in accordance with the present invention was prepared with the following ingredients as described in the table “%” refers to “weight-%”

TABLE 1

| Ingredients | % Ingredients |
|---|---|
| Pea Protein Isolate | 3.0 |
| Oat flour | 8.5 |
| Fruit and Vegetable blend | 80.2 |
| Beetroot puree | 14.7 |
| Pomegranate juice | 14.1 |
| Apple juice | 6.6 |
| White Grape Juice | 8.0 |
| Fig puree | 11.5 |
| Cherry juice | 6.7 |
| Rhubarb puree | 6.1 |
| Parsnip puree | 6.1 |
| Lemon juice | 2.4 |
| Black carrot juice | 4.0 |
| Natural rosemary flavoring | 0.3 |
| Nut and Seed Mix | 8.3 |
| Walnuts | 3.3 |
| Pistachio nuts | 2.1 |
| Sunflower seeds | 1.7 |
| Pumpkin seeds | 1.2 |
| Total | 100 |

First, the fruit and vegetable blend were prepared by weighing and mixing all the wet ingredients. Next the pea protein isolate and the oat flour were weighed and added to the wet blend and mixed thoroughly to ensure hydration and homogeneity. Then the composition was adjusted to pH 4.2 through the addition of lemon juice. Then 275 g of the resulting composition was filled into a polypropylene retortable tub and was sealed using a polypropylene heat seal membrane. Finally, pasteurization of the composition was carried out in an autoclave at a temperature of 93.3° C. for 2.5 mins, and subsequent cooling was carried to ambient temperature before storage.

25 g of the nuts and seeds were weighed and packed separately in sachets which will be added to the pasteurized product composition before consumption.

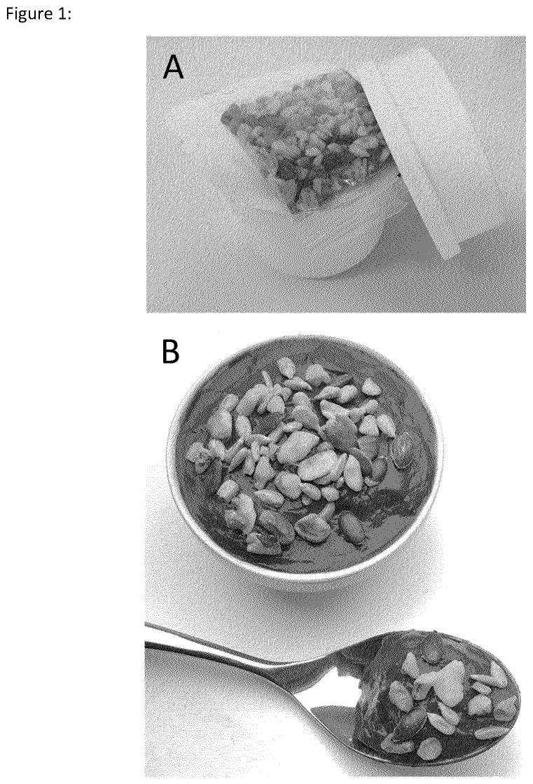

FIG. 1 shows the packaged spoonable ambient food composition (a) and after unwrapping (b).

Table 2 shows the nutritional values per 100 g and 300 g of product composition.

TABLE 2

| Nutrition Facts | 100 g | 300 g |
|---|---|---|
| Energy | 566 kJ | 1699 kJ |
| | 137 kcal | 410 kcal |
| Fat | 5.2 g | 16 g |
| of which saturates | 0.6 g | 1.9 g |
| Carbohydrate | 14 g | 42 g |
| of which Sugars | 7.9 g | 24 g |
| Fibre | 2.1 g | 6.2 g |
| Protein | 6.7 g | 20 g |
| Salt | 0.01 g | 0.02 g |

Table 3 shows the micronutrient content and % reference amount for daily intake of adults per 100 g and 300 g of product composition.

TABLE 3

| Micronutrients | 100 g | % DI | 300 g | % DI |
|---|---|---|---|---|
| Vitamin C | 6.6 mg | 7% | 20 mg | 22% |
| Vitamin B6 | 0.1 mg | 5% | 0.2 mg | 16% |
| Potassium | 181 mg | 5% | 542 mg | 15% |
| Phosphorus | 71.7 mg | 13% | 215 mg | 39% |
| Magnesium | 27.5 mg | 11% | 82.4 mg | 34% |
| Iron | 0.7 mg | 7% | 2.2 mg | 20% |
| Zinc | 0.6 mg | 5% | 1.8 mg | 15% |

### Example 2

Rheological properties of the spoonable ambient food composition were measured and Table 4 shows the results of apparent viscosity at a range of shear rates and the elastic modulus (G′) values within the linear viscoelastic region (LVR), at the same strain.

TABLE 4

| | Apparent viscosity | | | | G′ (Pa) |
|---|---|---|---|---|---|
| | (Pa · s) | | | | (within |
| Sample | 1 s⁻¹ | 10 s⁻¹ | 50 s⁻¹ | 1000 s⁻¹ | LVR) |
| Spoonable ambient | 110 | 22 | 8 | 1 | 815 |
| food composition | | | | | |

### Example 3

A composition in accordance with the present invention was prepared with the following ingredients as described in Table 1. “%” refers to “weight-%”

TABLE 5

| Ingredients | % Ingredients |
|---|---|
| Pea Protein Isolate | 2.2 |
| Oat flour | 8.5 |
| Low fat Cocoa Powder | 2.5 |
| Fruit and Vegetable blend | 78.5 |
| Raspberry puree | 19.5 |
| Apple juice | 17.7 |
| Fig puree | 11.8 |
| Banana puree | 8.2 |
| Cauliflower puree | 8.2 |
| Pear puree | 7.7 |
| Lemon juice | 3.2 |
| Blueberry juice | 2.4 |
| Nut and Seed Mix | 8.3 |
| Walnuts | 3.3 |
| Pistachio nuts | 2.1 |
| Sunflower seeds | 1.7 |
| Pumpkin seeds | 1.2 |
| Total | 100 |

First, the fruit and vegetable blend were prepared by weighing and mixing all the wet ingredients. Next the pea protein isolate and the oat flour were weighed and added to the wet blend and mixed thoroughly to ensure hydration and homogeneity. Then the composition was adjusted to pH 4.2 through the addition of lemon juice. Then 275 g of the resulting composition was filled into a polypropylene retortable tub and was sealed using a polypropylene heat seal membrane. Finally, pasteurization of the composition was carried out in an autoclave at a temperature of 93.3° C. for 2.5 mins, and subsequent cooling was carried to ambient temperature before storage.

25 g of the nuts and seeds were weighed and packed separately in sachets which will be added to the pasteurized product composition before consumption.

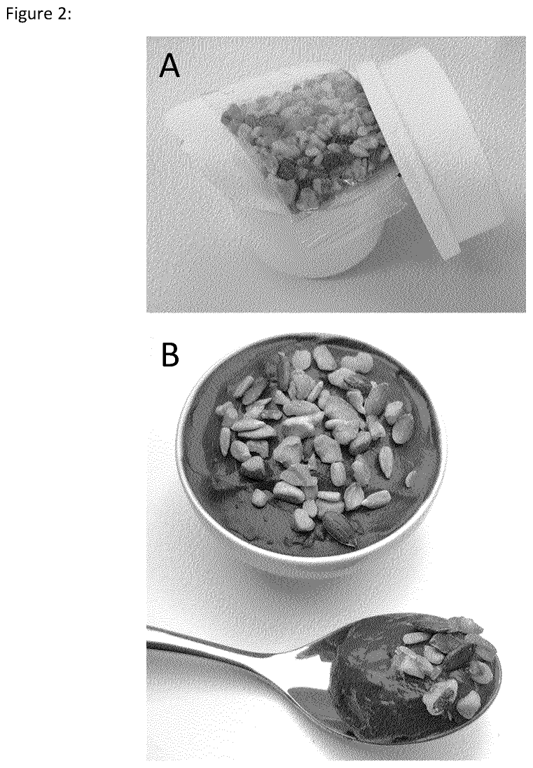

FIG. 2 shows the packaged spoonable ambient food composition (a) and after unwrapping (b).

Table 6 shows the nutritional values per 100 g and 300 g of product composition.

TABLE 6

| Nutrition Facts | 100 g | 300 g |
|---|---|---|
| Energy | 590 kJ | 1771 kJ |
| | 143 kcal | 430 kcal |
| Fat | 5.5 g | 16 g |
| of which saturates | 0.8 g | 2.4 g |
| Carbohydrate | 14 g | 43 g |
| of which Sugars | 7.8 g | 23 g |
| Fibre | 3.2 g | 9.5 g |
| Protein | 6.8 g | 20 g |
| Salt | 0.00 g | 0.01 g |

Table 7 shows the micronutrient content and % reference amount for daily intake of adults per 100 g and 300 g of product composition.

TABLE 7

| Micronutrients | 100 g | % DI | 300 g | % DI |
|---|---|---|---|---|
| Vitamin E | 0.6 mg | 5% | 1.8 mg | 16% |
| Vitamin C | 7.4 mg | 7% | 22 mg | 22% |
| Vitamin B6 | 0.1 mg | 7% | 0.3 mg | 21% |
| Potassium | 266 mg | 8% | 798 mg | 23% |
| Phosphorus | 80.6 mg | 15% | 242 mg | 44% |
| Magnesium | 37.4 mg | 15% | 112 mg | 45% |
| Iron | 1.2 mg | 11% | 3.7 mg | 33% |
| Zinc | 0.7 mg | 6% | 2.2 mg | 18% |

### Example 4

Rheological properties of the spoonable ambient food composition were measured and Table 4 shows the results of apparent viscosity at a range of shear rates and the elastic modulus (G′) values within the linear viscoelastic region (LVR), at the same strain.

TABLE 8

| | Apparent viscosity | | | | G′ (Pa) |
|---|---|---|---|---|---|
| | (Pa · s) | | | | (within |
| Sample | 1 s⁻¹ | LVR) | 50 s⁻¹ | 1000 s⁻¹ | LVR) |
| Spoonable ambient | 140 | 25 | 10 | 1.3 | 1400 |
| food composition | | | | | |

### Example 5

A composition in accordance with the present invention was prepared with the following ingredients as described in Table 1. “%” refers to “weight-%”

TABLE 9

| Ingredients | % Ingredients |
|---|---|
| Pea Protein Isolate | 3.0 |
| Oat flour | 8.5 |
| Fruit and Vegetable blend | 80.2 |
| Pumpkin puree | 19.0 |
| Pineapple juice | 11.9 |
| Apricot juice | 11.9 |
| Apple juice | 10.1 |
| Grape juice | 9.6 |
| Sweet potato puree | 5.9 |
| Lemon juice | 5.9 |
| Organic Ginger juice | 3.5 |
| Coconut milk | 2.0 |
| Organic turmeric | 0.4 |
| Nut and Seed Mix | 8.3 |
| Walnuts | 3.3 |
| Pistachio nuts | 2.1 |
| Sunflower seeds | 1.7 |
| Pumpkin seeds | 1.2 |
| Total | 100 |

First, the fruit and vegetable blend were prepared by weighing and mixing all the wet ingredients. Next the pea protein isolate and the oat flour were weighed and added to the wet blend and mixed thoroughly to ensure hydration and homogeneity. Then the composition was adjusted to pH 4.2 through the addition of lemon juice. Then 275 g of the resulting composition was filled into a polypropylene retortable tub and was sealed using a polypropylene heat seal membrane. Finally, pasteurization of the composition was carried out in an autoclave at a temperature of 93.3° C. for 2.5 mins, and subsequent cooling was carried to ambient temperature before storage.

25 g of the nuts and seeds were weighed and packed separately in sachets which will be added to the pasteurized product composition before consumption.

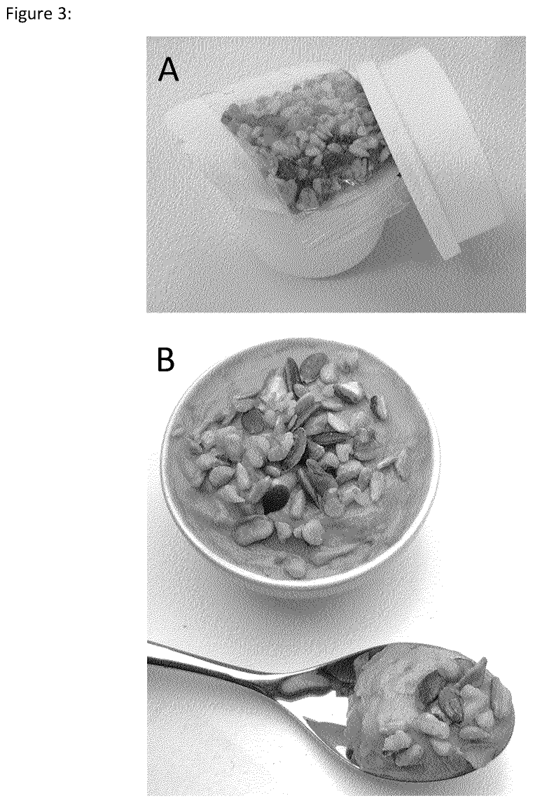

FIG. 3 shows the packaged spoonable ambient food composition (a) and after unwrapping (b).

Table 10 shows the nutritional values per 100 g and 300 g of product composition.

TABLE 10

| Nutrition Facts | 100 g | 300 g |
|---|---|---|
| Energy | 563 kJ | 1689 KJ |
| | 137 kcal | 410 kcal |
| Fat | 5.7 g | 17 g |
| of which saturates | 1.1 g | 3.3 g |
| Carbohydrate | 13 g | 38 g |
| of which Sugars | 6.3 g | 19 g |
| Fibre | 2.0 g | 5.9 g |
| Protein | 6.7 g | 20 g |
| Salt | 0.01 g | 0.02 g |

Table 11 shows the micronutrient content and % reference amount for daily intake of adults per 100 g and 300 g of product composition.

TABLE 11

| Micronutrients | 100 g | % DI | 300 g | % DI |
|---|---|---|---|---|
| Vitamin E | 1.0 mg | 9% | 2.98 mg | 27% |
| Vitamin B6 | 0.1 mg | 8% | 0.29 mg | 23% |
| Potassium | 197 mg | 6% | 590 mg | 17% |
| Phosphorus | 70.6 mg | 13% | 212 mg | 39% |
| Magnesium | 27.8 mg | 11% | 83.4 mg | 34% |
| Iron | 0.7 mg | 7% | 2.2 mg | 20% |
| Zinc | 0.6 mg | 5% | 1.8 mg | 15% |

### Example 6

Rheological properties of the spoonable ambient food composition were measured and Table 4 shows the results of apparent viscosity at a range of shear rates and the elastic modulus (G′) values within the linear viscoelastic region (LVR), at the same strain.

TABLE 12

| | Apparent viscosity | | | | G′ (Pa) |
|---|---|---|---|---|---|
| | (Pa · s) | | | | (within |
| Sample | 1 s⁻¹ | 10 s⁻¹ | 50 s⁻¹ | 1000 s⁻¹ | LVR) |
| Spoonable ambient | 135 | 25 | 10 | 1.1 | 1220 |
| food composition | | | | | |

1. Spoonable ambient food composition comprising pea protein and oat flour.

2. Spoonable ambient food composition according to claim 1, further comprising an ingredient selected from the group consisting of lemon juice, natural rosemary flavoring, and combinations thereof, and at least about 2 weight-% pea protein, at least about 7 weight % oat flour, at least about 13 weight-% beetroot puree, at least about 13 weight-% pomegranate juice, at least about 10 weight-% fig puree, at least about 7 weight-% grape juice, at least about 6 weight-% cherry juice, at least about 5 weight-% rhubarb puree, at least about 5 weight-% parsnip puree, and at least about 3 weight-% carrot juice.

3. Spoonable ambient food composition according to claim 1, further comprising an ingredient selected from the group consisting of lemon juice, blueberry juice, and combinations thereof and at least about 1.5 weight-% pea protein, at least about 7 weight % oat flour, at least about 2 weight-% cocoa, at least about 18 weight-% raspberry puree, at least about 16 weight-% apple juice, at least about 10 weight-% fig puree, at least about 7 weight-% banana puree, at least about 7 weight-% cauliflower puree, and at least about 7 weight-% pear puree.

4. Spoonable ambient food composition according to claim 1, further comprising an ingredient selected from the group consisting of ginger juice, coconut milk, turmeric, and combinations thereof and at least about 2 weight-% pea protein, at least about 7 weight % oat flour, at least about 18 weight-% pumpkin puree, at least about 10 weight-% pineapple juice, at least about 10 weight-% apricot juice, at least about 9 weight-% apple juice, at least about 8 weight-% grape juice, at least about 5 weight-% sweet potato puree, and at least about 5 weight-% lemon juice.

5. Spoonable ambient food composition in accordance with claim 1, wherein the composition has a viscosity in the range of about 20-25 Pa·s at 10⁻⁵ shear rate.

6. Spoonable ambient food composition in accordance with claim 1, wherein the composition further comprises a nut and seed mix, wherein the nut and seed mix may comprise nuts and seeds selected from the group consisting of walnuts, pistachios, sunflower seeds, pumpkin seeds, and combinations thereof.

7. Spoonable ambient food composition in accordance with claim 1, wherein the composition is obtainable by a method comprising the steps of:
mixing of the wet ingredients,
addition of the dry ingredients, and further mixing to ensure hydration and homogeneity,
adjustment of the pH to 4.5 or less, for example through the addition of lemon juice,
filling of the resulting product into retortable packaging,
pasteurization of the product in the retortable packaging at a temperature in the range of about 90-100° C., and
cooling of the product.

8. Spoonable ambient food composition in accordance with claim 1, wherein the composition comprises no added sugar and/or no added salt.

9. Spoonable ambient food composition in accordance with claim 1, wherein the composition is not fortified with vitamins or minerals.

10. Spoonable ambient food composition in accordance with claim 1, wherein the composition is gluten-free and/or is a vegetarian composition and/or is a vegan composition.

11. Spoonable ambient food composition in accordance with claim 1, wherein the composition is to be used to replace a complete meal, for example, lunch or dinner.

12. Spoonable ambient food composition in accordance with claim 1, wherein the composition is to be distributed through the ambient food chain.

13. Single serve pack comprising spoonable ambient food composition comprising pea protein and oat flour, wherein the single serve comprises about 250-350 g of the composition, and wherein a nut and seed mix is separated from the composition in the single serve pack and is to be added to the composition before consumption.

14. Single serve pack in accordance with claim 13, wherein the composition is pasteurized, and the single serve pack has a shelf life at ambient conditions of at least 6 months.
